(19) United States
(12) Patent Application Publication
(10) Pub. No.: US 2011/0068516 A1
(43) Pub. Date: Mar. 24, 2011

(54) PROCESS AND APPARATUS FOR PRODUCING A SHRINKABLE PLASTIC FILM BY ENVIRONMENT-FRIENDLY RESIN MATERIAL

(76) Inventor: Chi-Chan Yang, Changhua City (TW)

(21) Appl. No.: 12/991,936

(22) PCT Filed: May 28, 2008
(86) PCT No.: PCT/CN08/01787

§ 371 Date: Nov. 10, 2010

(30) Foreign Application Priority Data
May 28, 2008 (CN) 200810100188.1

(51) Int. Cl. B29C 69/00; B29C 49/18

(52) U.S. Cl. 264/555; 425/71

(57) ABSTRACT

An improved process and apparatus for producing a shrinkable plastic film by environment-friendly resin material. The process comprises blow-molding the environment-friendly resin material of OPS, PET or PLA to form a tubular plastic film by a blow-molding machine, and collapsing the tubular plastic film to a flattened plastic film by a roller, then passing through the first forcibly cooling device, the plastic film being transferred to the second heating device which is filled with heating water, and the third auxiliary heating device on the top of a transfer roller serving to heat the soften plastic film further, then the reheated plastic film being transferred to the fourth rapid-cooling device and the tube is cooled rapidly, then the tubular plastic film with improved toughness is achieved. The said auxiliary heating device with a wall around it is positioned on the top of the transfer roller, and the wall separates the water into two parts. In the wall, plural heaters are positioned to improve the water temperature in the wall, so when the flattened plastic film passes through the region in the wall, it will be reheated and the working temperature may be constant, and the flattened plastic film will be expanded easily by blowing.

### BACKGROUND OF THE INVENTION

1. Field of the Invention

The present invention relates to a process and apparatus for producing a shrinkable plastic film by environment-friendly resin material such as OPS, PET, and PLA.

2. Description of the Related Art

The conventional shrinkable plastic film is made of the PVC material and formed by a blow-molding machine to a tubular plastic film for being directly scrolled up. In fact, in view of the elasticity contained in the plastic film made of the PVC material, the PVC shrinkable plastic film could be commonly seen in the market. Herein, the PVC shrinkable plastic film has a wide application. For example, a printed PVC shrinkable plastic film tightly wrapping a surface of any container preferably provides an advertising effect and a marking object.

However, since such PVC material is gradually forbidden, various eco-friendly materials are developed. For example, materials like OPS (oriented polystyrene), PET (polyethylene terephthalate), or PLA (polyactide) are developed for substituting the PVC material so as to produce an environment-friendly shrinkable plastic film. Herein, the OPS and PET are nontoxic and the PLA could be decomposed naturally with no toxicant. Thus, abovementioned materials do not incur the second pollution. Therefore, the Government would support such a constructive development.

### SUMMARY OF THE INVENTION

The present invention is to utilize an improved process and apparatus for producing a shrinkable plastic film by environment-friendly resin material to solve the following problems:

1. The conventional plastic film is made of PVC and formed by blowing. However, such PVC material is unable to be decomposed; the second pollution is adversely resulted, and the environment is unfavorably damaged. Thus, products made of the PVC material should be gradually eliminated.

2. PVC fumes are easily emitted while the PVC material is heated and melted in the blow-molding machine. Pollution on human body and environment is resulted.

3. However, environment-friendly resin materials like the OPS, PET, or PLA have the unsatisfactory stretching elasticity while they are formed into a tubular plastic film by means of the blow-molding machine. The tubular plastic film made of the OPS, PET, or PLA material is largely stretched while scrolling in time of conveyance, and such tubular plastic film would be readily pulled apart, which contributes to an inferior product.

4. Even though abovementioned environment-friendly resin materials may have the superior elasticity, the thickness thereof is unable to be evenly distributed in time of the stretching during the conveyance, so that a broken film is still unwillingly acquired.

The present invention is achieved as follows:

An improved process for producing a shrinkable plastic film by environment-friendly resin material utilizes a blow-molding machine to form a tubular plastic film. Characterized in that the process includes steps of:

a. forming the environment-friendly resin material made of OPS, PET, or PLA by the blow-molding machine into the tubular plastic film, and collapsing the tubular plastic film into a flattened plastic film;

b. placing the flattened plastic film to a forcibly cooling device of a first step for the flattened plastic film to have the superior elasticity;

c. placing the flattened plastic film into a heating device of a second step for the flattened plastic film to be heated by a first heater disposed at a bottom of the heating device, thereby rapidly softening the flattened plastic film via a transfer roller;

d. placing the flattened plastic film into an auxiliary heating device of a third step for further heating a temperature thereof decreased by mixing with water, thereby preventing the flattened plastic film from sticking and fixing, which contributes to the even expansion by blowing;

e. blowing and forming the flattened plastic film that is softened into an even tubular plastic film;

f. placing the tubular plastic film into a rapid-cooling device of a fourth step for the fixed tubular plastic film to have the superior elasticity so as to enhance a shrinkage rate thereof; and

g. forming the tubular plastic film into the flattened plastic film along folding marks at two sides thereof via a roller, thereby scrolling the tubular plastic film up at an end of the roller.

The forcibly cooling device of the first step adopts a liquid temperature-reducing system or an air temperature-reducing system; a temperature in the forcibly cooling device of the first step is set below 20° C. in accordance with a thickness of the plastic film. Thereby, the flattened plastic film could be forcibly cooled and fixed for enhancing the elasticity thereof.

A water temperature of softening water filled in a hot water container or a heating box in the heating device of the second step is set between 70˜85° C. The first heater is disposed at a bottom of the heating device for heating and softening the flattened plastic film, so that the flattened plastic film is conveyed through the transfer roller for being blown and expanded.

The auxiliary heating device of the third step utilizes the transfer roller to dispose a wall thereabove. A plurality of second heaters are disposed within the wall for further heating the softening water. Thereby, the blown and expanded flattened plastic film does not stick even if an overheating is accidentally brought about by the first heater in time of heating of the second step. Accordingly, a mixed temperature within a blowing region is lower than an operating temperature, so that the tubular plastic film could be further heated in the wall during conveyance by means of the second heater. The re-heating temperature for auxiliarily softening the flattened plastic film made of OPS is set between 75˜78° C.; the re-heating temperature for auxiliarily softening the flattened plastic film made of PET is set between 80˜83° C.; the re-heating temperature for auxiliarily softening the flattened plastic film made of PLA is set between 65˜68° C. The plastic film is evenly expanded by blowing.

The rapid-cooling device of the fourth step allows the tubular plastic film entering into a rapid-cooling pipe for further fixing the tubular plastic film and promoting the elasticity as well as the heat shrinkage rate of the tubular plastic film.

An inner wall of the rapid-cooling pipe defines a hollow cooling channel therein; the cooling channel includes an inlet pipe and an outlet pipe; the temperature within the cooling channel is set below 15° C.

A molding head of the blow-molding machine has a molding core, around an outer periphery of which entrance holes made of the environment-friendly resin material are defined at a bottom; an initial point of the entrance hole is installed relative to a proper angle and upwardly extended along a spiral groove; the environment-friendly resin material enters the entrance holes of the molding core via the blow-molding machine for being evenly stirred along the spiral groove; the environment-friendly resin material is concurrently expanded via air blown from a blowing hole at a center of the molding core along an interstice formed between the molding core and the molding head, so that the environment-friendly resin material is accordingly formed into the tubular plastic film including a film wall with an even thickness.

A relay roller is disposed between the forcibly cooling device of the first step and the heating device of the second step; compressing and conveying the flattened plastic film via the relay roller that is motivated by a motor lessen a tensile strength imparted from the transfer roller to the flattened plastic film, which prevents the flattened plastic film from a decreasing shrinkage rate while stretching.

The present invention is also achieved by an apparatus as follows:

An apparatus for producing a shrinkable plastic film by environment-friendly resin material comprises:

a blow-molding machine disposed on an outer periphery of a molding core of a molding head for blow-molding a tubular plastic film; at a bottom of the molding core, an initial hole of an entrance hole made of the environment-friendly resin material being disposed at a proper angle for upwardly extending along a spiral groove; the environment-friendly resin material being compressed into the entrance hole of the molding core via the blow-molding machine; heated by a heater in the molding head, the environment-friendly resin material being melted and mixed evenly while traveling through the spiral groove of the molding core; the environment-friendly resin material thence being formed into the tubular plastic film with an even thickness along an interstice formed between the molding core and the molding head;

a forcibly cooling device disposed between the molding head of the blow-molding machine and a heating device of a second step; a liquid temperature-reducing system or an air temperature-reducing system being installed in the forcibly cooling device; a fixing roller mounted within the forcibly cooling device auxiliarily allowing a flattened plastic film to pass through and to be forcibly fixed by the cooling liquid or the cooling air;

a relay roller disposed between the forcibly cooling device and a transfer roller of the heating device of the second step;

a heating device disposed between the relay roller and an auxiliary heating device of a third step; softening water being filled in the heating device; a first heater being disposed at a bottom of the heating device, and the transfer roller is disposed above the first heater;

an auxiliary heating device disposed between a rapid-cooling device of a fourth step and the transfer roller of the heating device of the second step;

the auxiliary heating device separating the softening water via a wall; a plurality of second heaters being disposed in the wall; despite an unsatisfactory mixed water temperature, heating the softening water in the wall would preferably soften the flattened plastic film, so that the flattened plastic film remaining softened; the tubular plastic film being accordingly expanded by air and shaped; and

the rapid-cooling device disposed in back of the auxiliary heating device of the third step, the rapid-cooling device including a hollow cooling channel defined in a pipe wall of a rapid-cooling pipe; the rapid-cooling device rapidly cooling the tubular plastic film that is expanded by air for forming the shrinkable plastic film with the superior elasticity.

The present invention has the following advantages:

1. The environment-friendly resin material adopts the OPS, PET, or PLA that provides an eco-friendly effect since these materials could be naturally decomposed.

2. The auxiliary heating device of the third step provides a compensatory heating so as to allow the flattened plastic film to be readily blown and expanded for forming the tubular plastic film.

3. The rapid-cooling device of the fourth step allows the produced plastic film made of the environment-friendly resin material having the superior elasticity and a promoted shrinkage rate.

### BRIEF DESCRIPTION OF THE DRAWINGS

FIG. 1 is a flowchart showing the process of the present invention;

FIG. 2A is partial cross-sectional view showing a molding head of the present invention;

FIG. 2B is a cross-sectional view showing the molding head of the present invention;

FIG. 2C is a perspective view showing the molding head of the present invention;

FIG. 3 is schematic view showing the process of the present invention;

FIG. 4 is a schematic view showing a tubular plastic film traveling through a rapid-cooling pipe of the present invention;

FIG. 4A is a perspective and cross-sectional view showing the rapid-cooling pipe; and

FIG. 4B is a cross-sectional showing the rapid-cooling pipe.

### DETAILED DESCRIPTION OF THE PREFERRED EMBODIMENTS

Understandable embodiments would provide a clear performance of the present invention as follows:

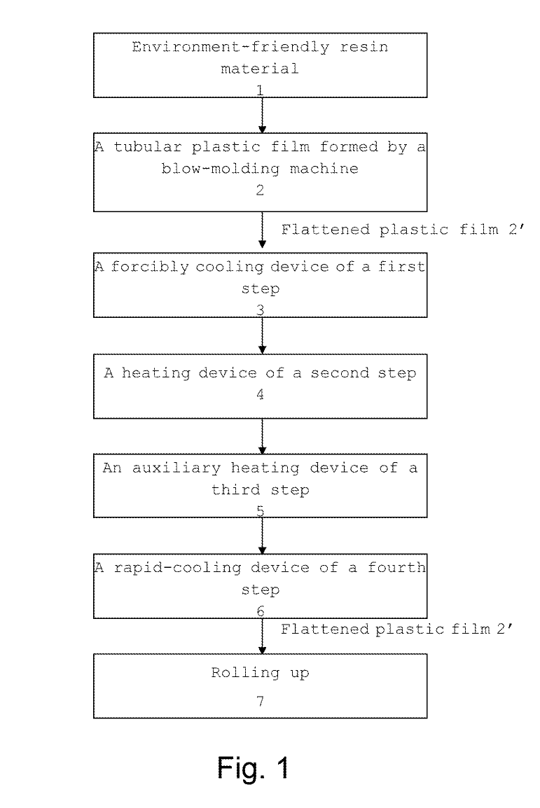

Referring to FIGS. 1 to 3A, a blow-molding machine A is utilized for forming a tubular plastic film 2 by materials like OPS, PET, or PLA. The tubular plastic film 2 is collapsed into a flattened plastic film 2′. Placing the flattened plastic film 2′ to a forcibly cooling device 3 in a first step allows the flattened plastic film 2′ to have the superior elasticity. Placing the flattened plastic film 2′ into a heating device 4 of a second step allows the flattened plastic film 2′ to be heated by a first heater 41 disposed at a bottom of the heating device 4, thereby rapidly softening the flattened plastic film 2′ via a transfer roller 42. Accordingly, the temperature of the flattened plastic film 2′ close to the first heater 41 is higher than the average temperature of softening water 40 in a normal state. By means of the collapsing of the transfer roller 42, the flattened plastic film 2′ travels above the transfer roller 42. Herein, if the flattened plastic film 2′ directly entered between a rapid-cooling pipe 61 of a rapid-cooling device 6 of a fourth step and the transfer roller 42, the flattened plastic film 2′ might be stuck and fixed since the mixed water results in a reduced water temperature. Consequently, the flattened plastic film 2′ is unable (or difficult) to be expanded for forming the tubular plastic film 2. Therefore, placing the flattened plastic film 2′ into an auxiliary heating device 5 of a third step for further heating a temperature thereof decreased by mixing with water would preferably prevent the flattened plastic film 2′ from sticking and fixing, which contributes to the even expansion for forming the tubular plastic film 2 by blowing.

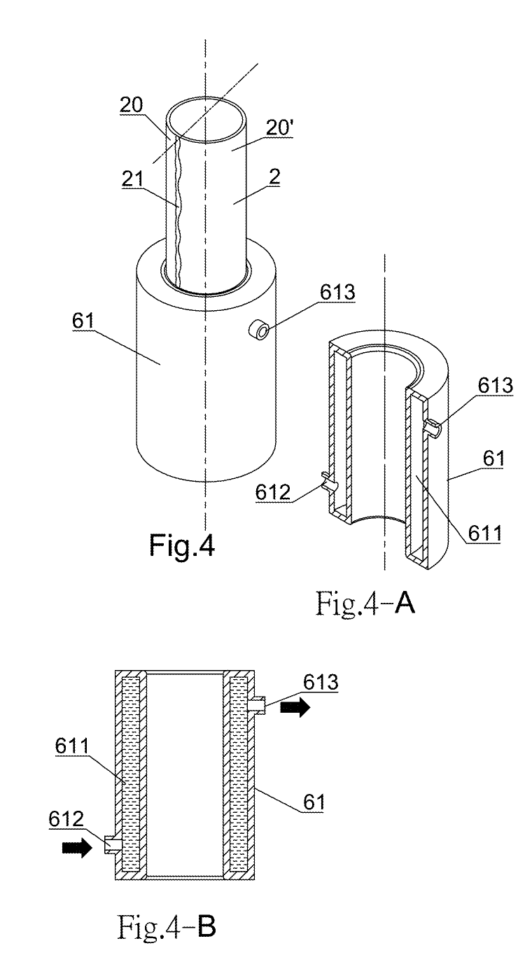

Placing the tubular plastic film 2 into the rapid-cooling pipe 61 (as shown in FIGS. 4A and 4B) of the rapid-cooling device 6 of a fourth step creates the superior elasticity on the fixed tubular plastic film 2 so as to enhance a shrinkage rate thereof. Forming the tubular plastic film 2 into the flattened plastic film 2′ along folding marks 21 at two sides thereof via a roller allows a scrolling 7 to reel the tubular plastic film 2 up at an end of the roller. Thereby, a printed shrinkable plastic film could tightly wrap a surface of any container in view of the preferable promoted heating shrinkage, and a nontoxic product could be achieved.

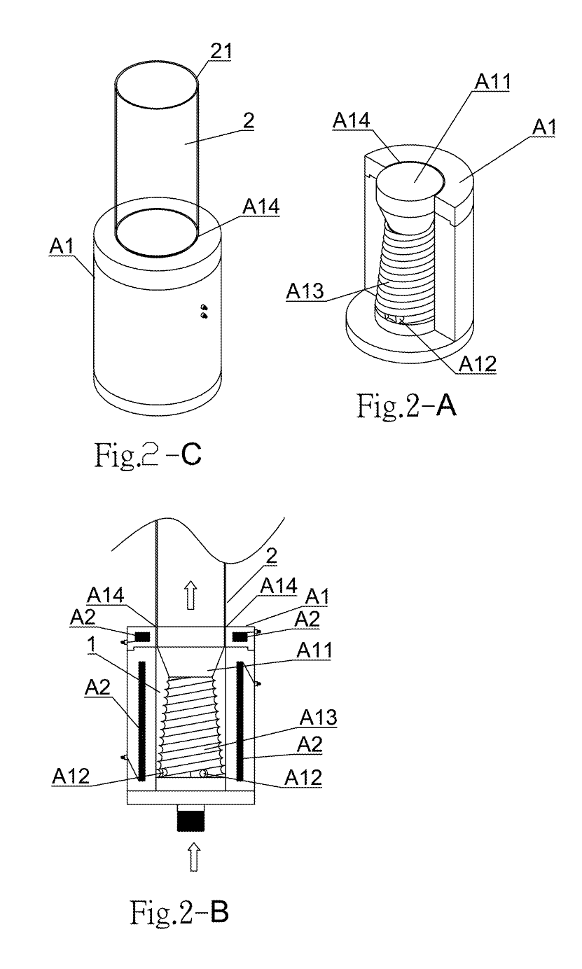

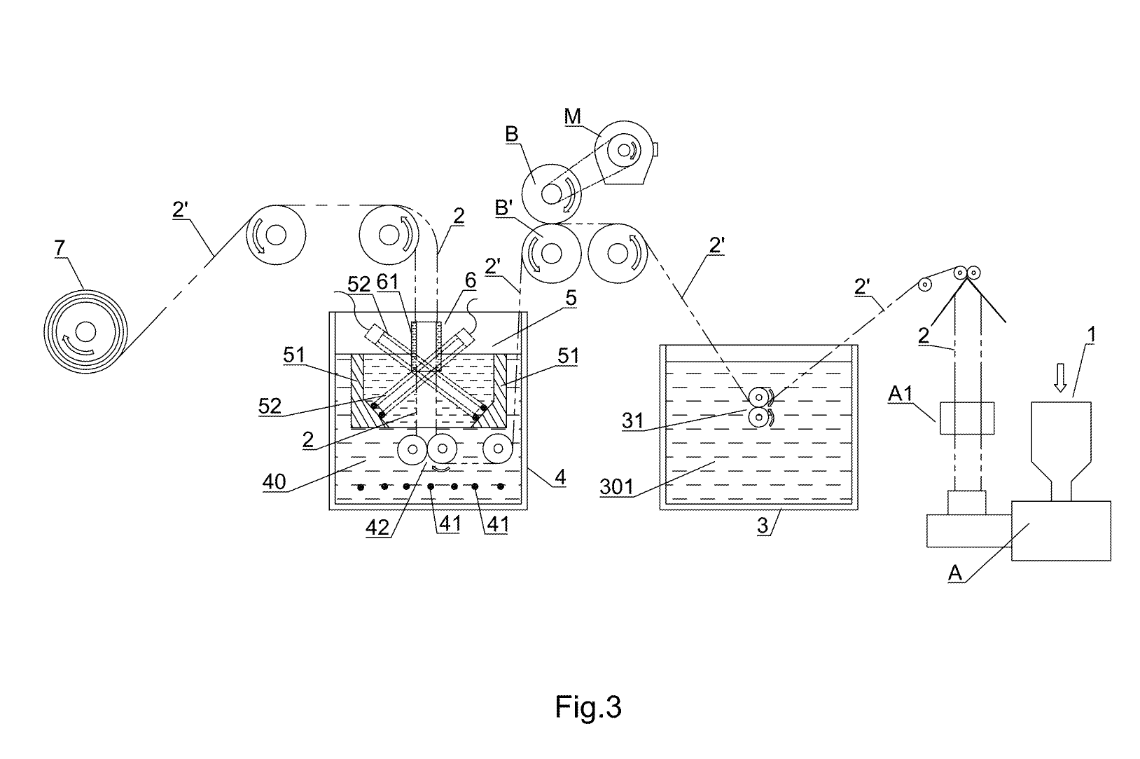

Referring to FIGS. 2 and 3, the flattened plastic film 2′ traveling through the forcibly cooling device 3 of the first step that adopts a liquid temperature-reducing system 301 or an air temperature-reducing system 301 allows a temperature in the forcibly cooling device 3 of the first step to be set below 20° C. in accordance with a thickness of the plastic film 2′. Thereby, the flattened plastic film 2′ could be forcibly cooled and fixed by the forcibly cooling device 3 for enhancing the elasticity thereof.

Referring to FIGS. 3 to 4, a hot water container in the heating device 4 of the second step receives the water whose temperature is set between 70˜85° C. for softening the flattened plastic film 2′ that passes through the heating device 4 so as to blow-mold the tubular plastic film 2.

Referring to FIG. 3, the auxiliary heating device 5 of the third step is disposed between the rapid-cooling pipe 61 and the transfer roller 42. The auxiliary heating device 5 disposes a wall 51 to separate the softening water 40. A plurality of second heaters 52 are disposed within the wall 51 for further heating the softening water 40 and auxiliarily softening the flattened plastic film 2, so as to compensate for a lack of the temperature of the plastic film mixed with the water. Thereby, the flattened plastic film 2′ remains softened for being blown and for expansibly forming the tubular plastic film 2. Accordingly, the rapid-cooling device 6 of the fourth step allows the tubular plastic film 2 entering into the rapid-cooling pipe 61 (as shown in FIGS. 4A and 4B) for promoting the elasticity as well as the heat shrinkage rate of the tubular plastic film 2 by means of a rapid cooling.

A re-heating temperature for further heating the softening water 40 in the wall 51 is set in accordance with features of different materials. The re-heating temperature for auxiliarily softening the flattened plastic film 2′ made of OPS is set between 75˜78° C. the re-heating temperature for auxiliarily softening the flattened plastic film 2′ made of PET is set between 80˜83° C.; the re-heating temperature for auxiliarily softening the flattened plastic film 2′ made of PLA is set between 65˜68° C. Thereby, the blown and expanded flattened plastic film 2′ does not stick so as to achieve the evenly expanded tubular plastic film 2.

Referring to FIGS. 1 and 3 to 4, the rapid-cooling device 6 of the fourth step allows the tubular plastic film 2 entering into the rapid-cooling pipe 61 for further fixing the tubular plastic film 2 and promoting the elasticity as well as the heat shrinkage rate of the tubular plastic film 2.

Referring to FIGS. 3, 4, 4A, and 4B, an inner wall of the rapid-cooling pipe 61 defines a hollow cooling channel 611 therein; the cooling channel 611 includes an inlet pipe 612 and an outlet pipe 613; the temperature within the cooling channel 611 is set below 15° C. Thereby, the tubular plastic film 2 flows within the hollow cooling channel 611 via the inlet pipe 612 and the outlet pipe 613.

Referring to FIGS. 3 and 2A to 2C, a molding head A1 of the blow-molding machine A has a molding core A11, around an outer periphery of which entrance holes A12 made of the environment-friendly resin material 1 are defined at a bottom. An initial point of the entrance hole A12 is installed relative to a proper angle and upwardly extended along a spiral groove A13. The environment-friendly resin material 1 enters the entrance holes A12 of the molding core A11 via the blow-molding machine A for being evenly stirred along the spiral groove A13. The environment-friendly resin material 1 is accordingly formed into the tubular plastic film 2 that includes a film wall 21 comprising an even thickness along an interstice A14 between the molding core A11 and the molding head A1. Thereby, the shrinkage rate of the film could be promoted.

Referring to FIG. 3, a relay roller B, B′ is disposed between the forcibly cooling device 3 of the first step and the heating device 4 of the second step. Compressing and conveying the flattened plastic film 2′ via the relay roller B, B′ that is motivated by a motor M lessen a tensile strength imparted from the transfer roller 42 to the flattened plastic film 2′, which prevents the flattened plastic film 2′ from a decreasing shrinkage rate while stretching.

Referring to FIGS. 2A to 2C, 3, 4, 4A, and 4B, the blow-molding machine A is disposed on the outer periphery of the molding core A11 of the molding head A1 for blow-molding the tubular plastic film 2. The initial hole of the entrance hole A12 made of the environment-friendly resin material 1 is disposed with a proper angle for upwardly extending along the spiral groove A13. The environment-friendly resin material 1 is compressed into the entrance hole A12 of the molding core A11 via the blow-molding machine A. Heated by the heater A2 in the molding head A1, the environment-friendly resin material 1 is melted and mixed evenly while traveling through the spiral groove A13 of the molding core A11. The environment-friendly resin material 1 is thence formed into the tubular plastic film 2 with an even thickness along an interstice A14 between the molding core A11 and the molding head A1 for promoting the shrinkage rate thereof.

The forcibly cooling device 3 is disposed between the molding head A1 of the blow-molding machine A and the heating device 4 of the second step. A liquid temperature-reducing system or an air temperature-reducing system 301 is installed in the forcibly cooling device 3. A fixing roller 31 mounted within the forcibly cooling device 3 auxiliarily allows the flattened plastic film 2′ to pass through and to be forcibly fixed by the cooling liquid or the cooling air.

The relay roller B, B′ is disposed between the forcibly cooling device 3 and the transfer roller 42 of the heating device 4 of the second step.

The heating device 4 is disposed between the relay roller B, B′ and the auxiliary heating device 5 of the third step. Softening water 40 is filled in the heating device 4. The first heater 41 is disposed at the bottom of the heating device 4, and the transfer roller 42 is disposed above the first heater 41.

The auxiliary heating device 5 is disposed between the rapid-cooling device 6 of the fourth step and the transfer roller 42 of the heating device 4 of the second step. The auxiliary heating device 5 separates the softening water 40 via the wall 51. A plurality of second heaters 52 are disposed in the wall 51. Despite an unsatisfactory mixed water temperature, heating the softening water 40 via the wall 51 would preferably soften the flattened plastic film 2′. Therefore, the flattened plastic film 2′ remains softened. The tubular plastic film 2 is remained soft and accordingly expanded by air and shaped.

The rapid-cooling device 6 is disposed in back of the auxiliary heating device 5 of the third step. The rapid-cooling device 6 includes the hollow cooling channel 611 defined in the pipe wall of the rapid-cooling pipe 61. The rapid-cooling device 6 rapidly cools the tubular plastic film 2 that is expanded by air for forming the shrinkable plastic film with the superior elasticity.

While we have shown and described the embodiment in accordance with the present invention, it should be clear to those skilled in the art that further embodiments may be made or modified without departing from the scope of the present invention.

I claim:

1. An improved process for producing a shrinkable plastic film by environment-friendly resin material utilizing a blow-molding machine to form a tubular plastic film; characterized in that said process comprising the steps of:
a. forming said environment-friendly resin material made of OPS, PET, or PLA by said blow-molding machine into said tubular plastic film, and collapsing said tubular plastic film into a flattened plastic film;
b. placing said flattened plastic film to a forcibly cooling device in a first step for said flattened plastic film to have the superior elasticity;
c. placing said flattened plastic film into a heating device of a second step for said flattened plastic film to be heated by a first heater disposed at a bottom of said heating device, thereby rapidly softening said flattened plastic film via a transfer roller;
d. placing said flattened plastic film into an auxiliary heating device of a third step for further heating a temperature thereof decreased by mixing with water, thereby preventing said flattened plastic film from sticking and fixing and contributing to the even expansion by blowing;
e. blowing and forming said flattened plastic film that is softened into an even tubular plastic film;
f. placing said tubular plastic film into a rapid-cooling device of a fourth step for said fixed tubular plastic film to have the superior elasticity so as to enhance a shrinkage rate thereof; and
g. forming said tubular plastic film into said flattened plastic film along folding marks at two sides thereof via a roller, thereby scrolling said tubular plastic film up at an end of said roller.

2. The process as claimed in claim 1, wherein, said forcibly cooling device of said first step adopts a liquid temperature-reducing system or an air temperature-reducing system; a temperature in said forcibly cooling device of said first step is set below 20° C. in accordance with a thickness of said plastic film.

3. The process as claimed in claim 1, wherein a water temperature of softening water filled in said heating device of said second step is set between 70˜85° C.

4. The process as claimed in claim 1, wherein, said auxiliary heating device of said third step is installed between a rapid-cooling pipe and said transfer roller for separating said softening water via a wall; a plurality of second heaters are disposed within said wall for further heating said softening water and auxiliarily softening said flattened plastic film, so as t compensate for a lack of said temperature of said plastic film mixed with said water; said flattened plastic film remains softened for being blown and expanded so as to form said tubular plastic film.

5. The process as claimed in claim 4, wherein, a re-heating temperature for further heating said softening water in said wall in said auxiliary heating device of said third step is set in accordance with features of different materials; said re-heating temperature for auxiliarily softening said flattened plastic film made of OPS is set between 75˜78° C.; said re-heating temperature for auxiliarily softening said flattened plastic film made of PET is set between 80˜83° C.; said re-heating temperature for auxiliarily softening said flattened plastic film made of PLA is set between 65˜68° C.; said flattened plastic film is prevented from sticking and fixing while being softened, which is evenly expanded by blowing to form into said tubular plastic film.

6. The process as claimed in claim 1, a rapid-cooling pipe in said rapid-cooling device of said fourth step is disposed above a fixing unit; an inner wall of said rapid-cooling pipe defines a hollow cooling channel therein; said cooling channel includes an inlet pipe and an outlet pipe; the temperature within said cooling channel is set below 15° C. for said tubular plastic film traveling through said hollow cooling channel via said inlet pipe and said outlet pipe.

7. The process as claimed in claim 1, wherein, a molding head of said blow-molding machine has a molding core, around an outer periphery of which entrance holes made of said environment-friendly resin material are defined at a bottom; an initial point of said entrance hole is installed relative to a proper angle and upwardly extended along a spiral groove; said environment-friendly resin material enters said entrance holes of said molding core via said blow-molding machine for being evenly stirred along said spiral groove; said environment-friendly resin material is concurrently expanded via air blown from a blowing hole at a center of said molding core along an interstice formed between said molding core and said molding head, so that said environment-friendly resin material is formed into said tubular plastic film including a film wall with an even thickness.

8. The process as claimed in claim 1, wherein, a relay roller is disposed between said forcibly cooling device of said first step and said heating device of said second step; said flattened plastic film is compressed and conveyed via said relay roller that is motivated by a motor for lessening a tensile strength imparted from said transfer roller to said flattened plastic film, which prevents from decreasing a shrinkage rate of said flattened plastic film while stretching.

9. An apparatus for producing a shrinkable plastic film by environment-friendly resin material comprising:
a blow-molding machine disposed on an outer periphery of a molding core of a molding head for blow-molding a tubular plastic film; at a bottom of said molding core, an initial hole of an entrance hole made of said environment-friendly resin material being disposed at a proper angle for upwardly extending along a spiral groove; said environment-friendly resin material being compressed into said entrance hole of said molding core via said blow-molding machine; heated by a heater in said molding head, said environment-friendly resin material being melted and mixed evenly while traveling through said spiral groove of said molding core; said environment-friendly resin material being formed into said tubular plastic film with an even thickness along an interstice formed between said molding core and said molding head;
a forcibly cooling device disposed between said molding head of said blow-molding machine and a heating device of a second step; a liquid temperature-reducing system or an air temperature-reducing system being installed in said forcibly cooling device; a fixing roller mounted within said forcibly cooling device auxiliarily allowing a flattened plastic film to pass through and to be forcibly fixed by said cooling liquid or said cooling air;
a relay roller disposed between said forcibly cooling device and a transfer roller of said heating device of said second step;
a heating device disposed between said relay roller and an auxiliary heating device of a third step; softening water being filled in said heating device; a first heater being disposed at a bottom of said heating device, and said transfer roller is disposed above said first heater;
an auxiliary heating device disposed between a rapid-cooling device of a fourth step and said transfer roller of said heating device of said second step;
said auxiliary heating device separating said softening water via a wall; a plurality of second heaters being disposed in said wall; despite an unsatisfactory mixed water temperature, heating said softening water in said wall would preferably soften said flattened plastic film, so that said flattened plastic film remaining softened; said tubular plastic film being expanded by air and shaped; and
said rapid-cooling device disposed in back of said auxiliary heating device of said third step, said rapid-cooling device including a hollow cooling channel defined in a pipe wall of a rapid-cooling pipe; said rapid-cooling device rapidly cooling said tubular plastic film that is expanded by air for forming said shrinkable plastic film with the superior elasticity.
